(19) United States
(12) Patent Application Publication
(10) Pub. No.: US 2026/0070269 A1
(43) Pub. Date: Mar. 12, 2026

(54) FOAMED OUTSOLE FOR ARTICLE OF FOOTWEAR AND METHOD OF MANUFACTURE

(71) Applicant: NIKE, Inc., Beaverton, OR (US)

(72) Inventors: Samuel G. Lacey, Portland, OR (US); Bradley C. Tutmark, Aloha, OR (US); James M.F. Webster, Tigard, OR (US)

(73) Assignee: NIKE, Inc., Beaverton, OR (US)

(21) Appl. No.: 19/322,125

(22) Filed: Sep. 8, 2025

Related U.S. Application Data
(60) Provisional application No. 63/692,349, filed on Sep. 9, 2024.

(51) Int. Cl. B29C 44/06; A43B 13/04; B29K 21/00; B29K 105/04; B29L 31/50

(52) U.S. Cl. CPC B29C 44/06; A43B 13/04; B29K 2021/003; B29K 2105/04; B29L 2031/504

(57) ABSTRACT

A method of forming an outsole for an article of footwear. The method includes providing, at an injection system, a mold material, the mold material including a styrenic thermoplastic polymer, providing, at a barrel of the injection system, a foaming agent, and combining the foaming agent with the mold material and forming a mixture of the foaming agent and the mold material. The method also includes injecting the mixture into a mold assembly and forming, at the mold assembly, an outsole from the injected foamed mold material.

### CROSS REFERENCE TO RELATED APPLICATIONS

This application claims priority under 35 U.S.C. § 119(e) to U.S. Provisional Application No. 63/692,349, filed on Sep. 9, 2024. The disclosure of this prior application is considered part of the disclosure of this application and is hereby incorporated by reference in its entirety.

### FIELD

The present disclosure relates generally to a system for molding an outsole for an article of footwear, and more particularly, to a system for foaming a mold material for an outsole for an article of footwear.

### BACKGROUND

This section provides background information related to the present disclosure and is not necessarily prior art.

Articles of footwear conventionally include an upper and a sole structure. The upper may include any suitable material(s) to receive, secure, and support a foot on the sole structure. The upper may cooperate with laces, straps, or other fasteners to adjust the fit of the upper around the foot. A bottom portion of the upper, proximate to a bottom surface of the foot, attaches to the sole structure.

Sole structures generally include a layered arrangement extending between a ground surface and the upper. One layer of the sole structure includes an outsole that provides abrasion-resistance and traction with the ground surface. The outsole may be formed using injection molding of rubber materials. For example, the materials used for injection molding may include pellets or blown rubber. While rubber provides for abrasion resistance, the rubber material is typically heavy and stiff. In some instances, the rubber material may be blown, which improves the rigidity and weight of the overall outsole. However, blown rubber has a lower degree of durability. Often, midsoles are formed using a foaming method to add cushion and comfort, in contrast to the rigidity of outsoles. Typically, outsoles are formed using solid materials to prevent degradation of the outsole over time. Due to the standard rigidity and hardness of the outsoles, the midsoles are typically foamed to provide comfort during wear.

### DRAWINGS

The drawings described herein are for illustrative purposes only of selected configurations and not all possible implementations, and are not intended to limit the scope of the present disclosure.

FIG. 1 is a top perspective view of an article of footwear including a foamed outsole in accordance with the present disclosure;

FIG. 2A is a schematic view showing a cross section of an example configuration of an injection molding system in accordance with the principles of the present disclosure;

FIG. 2B is a schematic view showing the cross section of the injection molding system of FIG. 2A, where a molding material is extruded into a mold with chemical blowing agents added to the molding material;

FIG. 2C is a schematic view showing the cross section of the injection molding system of FIG. 2A, where a mold assembly is moved to a closed configuration;

FIG. 3A is a schematic view showing the cross section of another injection molding system in accordance with the principles of the present disclosure;

FIG. 3B is a schematic view showing the cross section of the injection molding system of FIG. 3A, where a molding material is extruded into a mold with a gas injected into the molding material;

FIG. 3C is a perspective view of the molded article of FIG. 5, showing a step of separating molded article sections;

FIG. 4A is a schematic view showing a cross section of another example configuration of an injection molding system in accordance with the principles of the present disclosure;

FIG. 4B is a schematic view showing the cross section of the injection molding system of FIG. 2A, where a molding material is extruded into a mold with microspheres added to the molding material;

FIG. 4C is a schematic view showing the cross section of the injection molding system of FIG. 2A, where a mold assembly is moved to a closed configuration;

FIG. 4D is a partial enlarged view showing the mold material with the microspheres;

FIG. 5 is a cross sectional view of a mold system in accordance with the principles of the present disclosure with foamed mold material injected around removable segments;

FIG. 6 is a cross-sectional view of the mold system of FIG. 5 with the removable segments removed and a second mold material deposited within cavities formed in the foamed mold material;

FIG. 7A is a perspective view a molded article in accordance with the present disclosure, the molded article formed from an extrusion process;

FIG. 7B is a perspective view of the separated molded article of FIG. 5A;

FIG. 8 is a cross sectional view of a foamed outsole in accordance with the present disclosure, the foamed outsole including ribs; and

FIG. 9 is a cross sectional view of a foamed outsole in accordance with the present disclosure, the foamed outsole including notches and a rib.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

An aspect of the disclosure provides a method of forming an outsole for an article of footwear. The method includes providing, at an injection system, a mold material, the mold material including a styrenic thermoplastic polymer, providing, at a barrel of the injection system, a foaming agent, and combining the foaming agent with the mold material and forming a mixture of the foaming agent and the mold material. The method also includes injecting the mixture into a mold assembly and forming, at the mold assembly, an outsole from the injected foamed mold material.

This aspect of the disclosure may include one or more of the following optional features and steps. In some examples, combining the foaming agent with the mold material may include injecting the foaming agent into the mold material at a nozzle of the injection system. The foaming agent may optionally include at least one of a chemical blowing agent, an injection gas, and microspheres. In some instances, forming the outsole may include forming a skin along mold plates of the mold assembly. Optionally, injecting the foamed mold material may include heating the microspheres of the foaming agent and expanding a volume of each of the microspheres within the foamed mold material. The method may also include defining notches in the outsole. In further examples, the method may include forming ribs of the outsole. The method may optionally include positioning one or more removable segments in the mold assembly to define one or more cavities of the outsole and injecting a second mold material into the cavities.

An outsole for an article of footwear may be formed using the method described above, and an article of footwear may include the outsole.

Another aspect of the disclosure provides a method of forming an outsole for an article of footwear. The method includes providing a mold material, the mold material including a styrenic thermoplastic elastomer and providing a foaming agent. The method also includes combining the foaming agent with the mold material and forming a mixture of the foaming agent and the mold material and forming a foamed outsole from the mixture.

This aspect of the disclosure may include one or more of the following optional features. In some examples, providing the mold material may include providing the mold material at an injection system and combining the foaming agent with the mold material may include injecting the foaming agent into the mold material at a nozzle of the injection system. The foaming agent may optionally include at least one of a chemical blowing agent, an injection gas, and microspheres. In some instances, forming the foamed outsole may include forming a skin along mold plates of the mold assembly. The method may also include injecting, into a mold assembly, the foamed mold material including the microspheres and expanding a volume of each of the microspheres within the foamed mold material. Optionally, the method may include defining notches in the foamed outsole. In some examples, the method may include forming ribs of the foamed outsole. The method may further include positioning one or more removable segments in a mold assembly to define one or more cavities of the foamed outsole and injecting a second mold material into the one or more cavities. In further examples, the method may include combining, with the mold material, at least one of a pigment and an abrasion resistance additive.

A foamed outsole for an article of footwear may be formed using the method described above.

The details of one or more implementations of the disclosure are set forth in the accompanying drawings and the description below. Other aspects, features, and advantages will be apparent from the description, the drawings, and the claims.

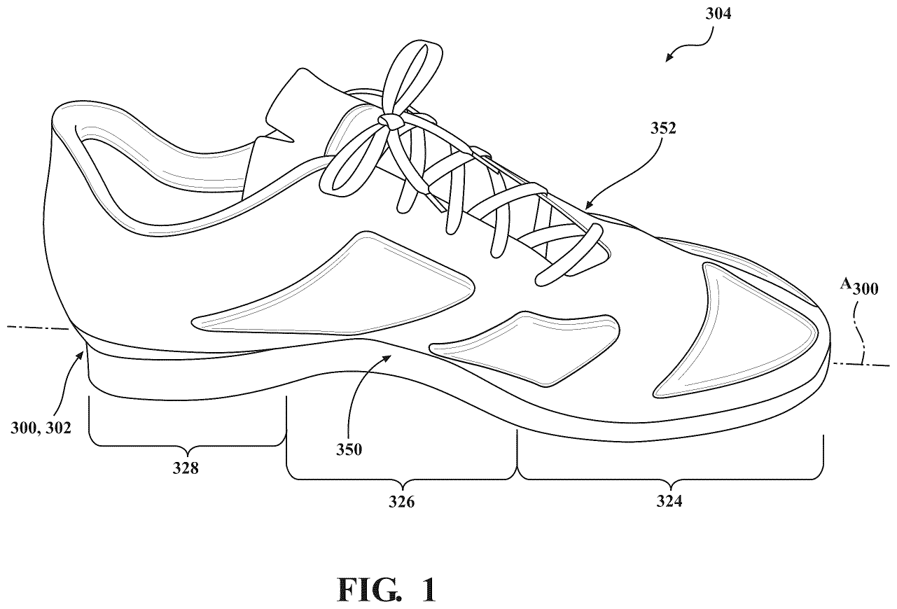

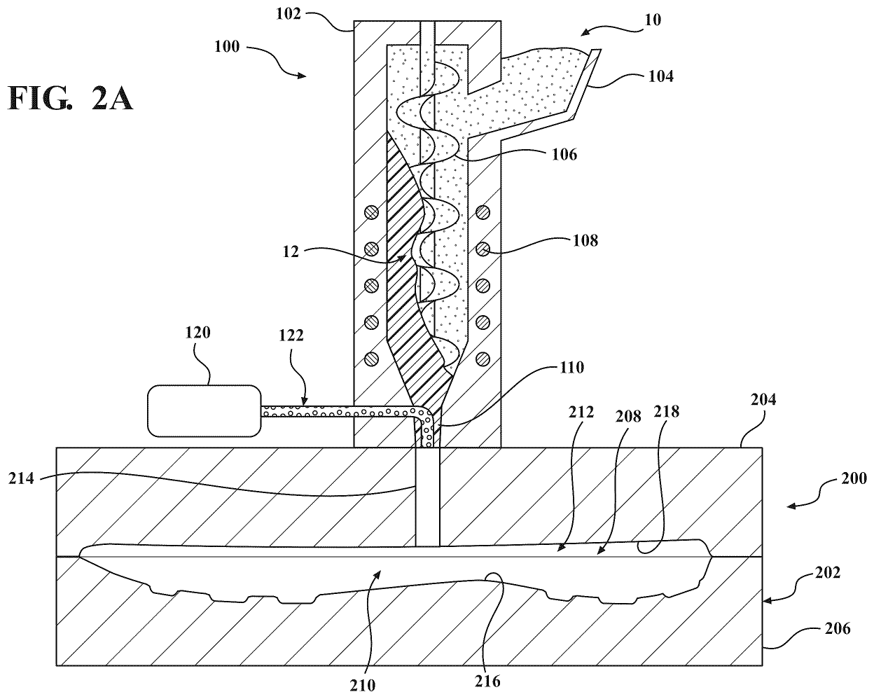

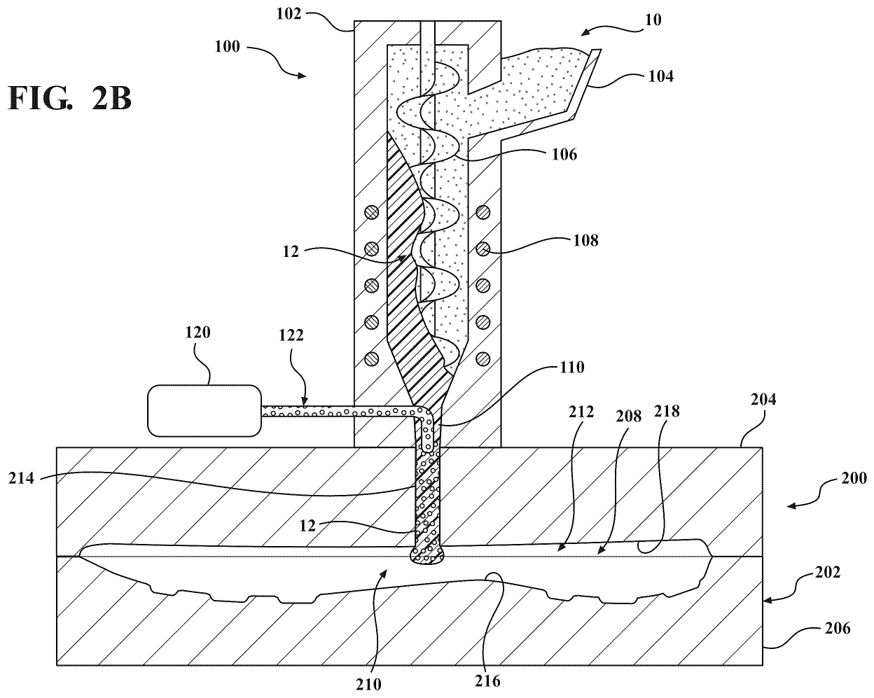

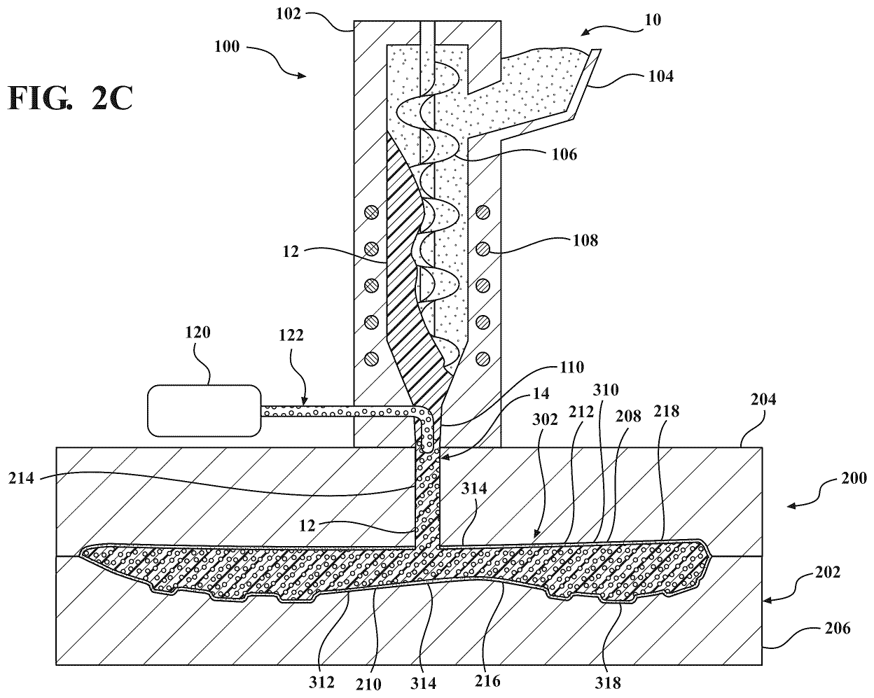

Referring to FIGS. 1-2C, a molding system 10 is provided according to an example of the present disclosure. In some examples, the molding system 10 may be a molding system 10 that includes an injection system 100 and a mold system 200 configured to produce an injection molded article 300 including an outsole 302 for use in manufacturing of an article of footwear 304. Thus, the outsole 302 is formed by use of the injection molding system 10.

The injection system 100 includes a barrel 102 configured to receive a mold material 12. While the illustrated example is provided with a single barrel 102 for the sake of clarity, it should be appreciated that the injection system 100 may include additional barrels as desired. The barrel 102 includes a hopper 104 for receiving the mold material 12 in a raw form, such as in a pellet form. The barrel 102 further includes a screw 106 and a heater 108 for heating the mold material 12 to a molten state. The barrel 102 includes a nozzle 110 disposed adjacent an end of the extruder screw 106 for receiving and dispensing the molten mold material 12.

Each of the nozzles 110 of the barrel 102 provides a passageway for the mold material 12a to exit the injection system 100. The nozzle 110 is configured to introduce the mold material 12 to the mold system 200. A secondary injector 120 is coupled to the barrel 102 and is configured to inject a foaming agent 122 into the mold material 12 at the nozzle 110. In some examples, the foaming agent 122 may include a chemical blowing agent configured to define air pockets or bubbles within the mold material 12, described in more detail below.

As set forth above, the injection system 100 is configured to inject the mold materials 12 into the mold system 200 in combination with the foaming agent 122. For example, the mold material 12 in combination with the foaming agent 122 is injected into the mold system 200 as a foamed mold material 14. The mold material 12 can comprise an elastomeric material that includes one or more thermoplastic polymers and/or one or more cross-linkable polymers. In an aspect, the elastomeric material can include one or more thermoplastic elastomeric materials, such as one or more thermoplastic polyurethane (TPU) copolymers, one or more ethylene-vinyl alcohol (EVOH) copolymers, and the like. In one example, the mold material 12 may be a styrenic thermoplastic elastomeric (TPE-S) material. The TPE-S material has a high styling content and degree of hardness durability. In other examples, the mold material 12 may be a thermoplastic vulcanisate (TPV) material.

As used herein, “polyurethane” refers to a copolymer (including oligomers) that contains a urethane group (—N(C═O)O—). These polyurethanes can contain additional groups such as ester, ether, urea, allophanate, biuret, carbodiimide, oxazolidinyl, isocynaurate, uretdione, carbonate, and the like, in addition to urethane groups. In an aspect, one or more of the polyurethanes can be produced by polymerizing one or more isocyanates with one or more polyols to produce copolymer chains having (—N(C═O)O—) linkages.

Examples of suitable isocyanates for producing the polyurethane copolymer chains include diisocyanates, such as aromatic diisocyanates, aliphatic diisocyanates, and combinations thereof. Examples of suitable aromatic diisocyanates include toluene diisocyanate (TDI), TDI adducts with trimethyloylpropane (TMP), methylene diphenyl diisocyanate (MDI), xylene diisocyanate (XDI), tetramethylxylylene diisocyanate (TMXDI), hydrogenated xylene diisocyanate (HXDI), naphthalene 1,5-diisocyanate (NDI), 1,5-tetrahydronaphthalene diisocyanate, para-phenylene diisocyanate (PPDI), 3,3′-dimethyldipheny 1-4, 4′-diisocyanate (DDDI), 4,4 ′-dibenzyl diisocyanate (DBDI), 4-chloro-1,3-phenylene diisocyanate, and combinations thereof. In some embodiments, the copolymer chains are substantially free of aromatic groups.

In particular aspects, the polyurethane polymer chains are produced from diisocynates including HMDI, TDI, MDI, H12 aliphatics, and combinations thereof. In an aspect, the thermoplastic TPU can include polyester-based TPU, polyether-based TPU, polycaprolactone-based TPU, polycarbonate-based TPU, polysiloxane-based TPU, or combinations thereof.

In another aspect, the polymeric layers can be formed of one or more of the following: EVOH copolymers, poly(vinyl chloride), polyvinylidene polymers and copolymers (e.g., polyvinylidene chloride), polyamides (e.g., amorphous polyamides), amide-based copolymers, acrylonitrile polymers (e.g., acrylonitrile-methyl acrylate copolymers), high-density polyethylene, polyethylene terephthalate, polyether imides, polyacrylic imides, and other polymeric materials. Blends of these materials as well as with the TPU copolymers described herein and optionally including combinations of polyimides and crystalline polymers, are also suitable.

Referring still to FIGS. 1-2C, the molding system 10 further includes a mold system 200 including a mold assembly 202. The mold assembly 202 includes a first mold plate 204 and a second mold plate 206, which are configured to interface with each other to define a mold chamber 208 configured to receive the foamed mold material 14. The first mold plate 204 defines a first mold cavity 210 corresponding to the profile of a top portion 310 of the outsole 302 to be molded using the injection molding system 10. The second mold plate 206 defines a second mold cavity 212 corresponding to the profile of a bottom portion 312 to be molded using the injection molding system 10. While the illustrated example shows mold plates 204, 206 each defining a single mold cavity 210, 212, the mold plates 204, 206 may be configured to include two or more of the mold cavities 210, 212.

Referring to FIG. 2B, a first step for forming a molded article 300 according to the present disclosure is shown. In FIG. 2A, the mold assembly 202 is initially provided at the injection system 100. The secondary injector 120 injects the foaming agent 122 into the mold material 12 within the barrel 102 proximate to the nozzle 110. Thus, the foaming agent 122 is mixed or otherwise combined with the mold material 12 at the nozzle 110 of the barrel 102. In some examples, the foaming agent 122 may be pre-combined with the mold material 12 in a master-batch. For example, the foaming agent 122 may be combined with the pellets of the mold material 12 deposited through the hopper 104 into the barrel 102. In other examples, the mold material 12 may be combined with a predetermined volume of the foaming agent 122 within the barrel 102. The foaming agent 122 provides air pockets within the mold material 12. The air pockets assist in offsetting the weight of the mold material 12. As mentioned above, the foaming agent 122 may be a chemical foaming agent 122 that is activated by heat defined by the heaters 108. The activation of the foaming agent 122 results in the foaming agent 122 expanding within the mold material 12 in response to the heat. The expansion of the foaming agent 122 defines the foamed mold material 14 that is subsequently injected into the mold system 200.

As depicted in FIG. 2B, the injection system 100 injects the foamed mold material 14, including the mold material 12 and the foaming agent 122, into the mold chamber 208 via a channel 214. As shown, the foamed mold material 14 fills the mold chamber 208 and the respective mold cavities 210, 212. The foamed mold material 14 is injected into the mold chamber 208 until the mold chamber 208 is filled with the foamed mold material 14 (FIG. 2C). At FIG. 2C, the mold assembly 202 is filled with the foamed mold material 14. Once deposited into the mold assembly 202, the foamed mold material 14 may form a skin 314 as an outer layer of the outsole 302 along a respective surface 216, 218 of the mold plates 204, 206. The skin 314 may define a solid layer at the mold plates 204, 206 with the foamed mold material 14 defining a foamed center 316, as an inner layer, disposed within the skin 314. The skin 314 may provide advantageous abrasion protection for the molded outsole 302, as the skin 314 may have a Shore hardness H₃₁₄ that is greater than a Shore hardness H₃₁₆ of the foamed center 316, described below. For example, the outsole 302 includes the outer layer 314 having a first hardness H₃₁₄ that is greater than a second hardness H₃₁₆ of the inner layer 316. The inner layer 316 includes the foamed center 316. Further, the outer layer 314 has a first density D₃₁₄ and the inner layer 316 has a second density D₃₁₆. The second density D₃₁₆ is less than the first density D₃₁₄ of the outer layer 314.

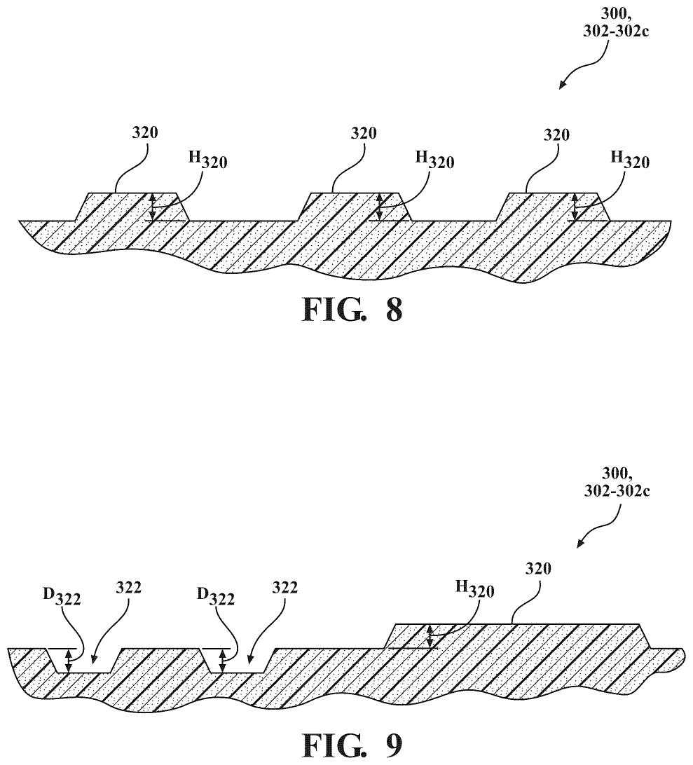

As shown, the mold cavities 210, 212 of the illustrated example are configured to form the outsole 302, which may have molded traction elements 318. Particularly, the first mold cavity 210 is configured to form the bottom portion 312 including the skin 314 and one or more traction elements 318. The second mold cavity 212 is configured to form the top portion 310 of the outsole 302, with the second mold plate 206 being configured to mate with the first mold plate 204. In some implementations, the mold plates 204, 206 may be configured to form one or more ribs 320 (FIGS. 8 and 9) and/or one or more notches 322 (FIG. 9). For example, the ribs 320 may extend from the outer layer or skin 314 and the notches 322 are defined in the outer layer or skin 314. The ribs 320 and the notches 322 may be formed along one or both of the top portion 310 and the bottom portion 312 of the outsole 302.

With further reference to FIGS. 1, 8, and 9, it is contemplated that the ribs 320 and the notches 322 may be formed by the first and/or second mold cavities 210, 212. The ribs 320 and notches 322 may be formed along a longitudinal axis A₃₀₀ of the molded article 300. For example, the ribs 320 and notches 322 may be defined at one or more of a forefoot region 324, a midfoot region 326, and a heel region 328. The ribs 320 and the notches 322 may each respectively extend along the longitudinal axis A₃₀₀ of the molded article 300 or a longitudinal axis A₃₀₂ of the outsole 302. In some configurations, the ribs 320 and notches 322 may extend along and/or between a medial side 350 and a lateral side 352 of the molded article 300. The ribs 320 and notches 322 may be further utilized to define a pattern along a ground-contacting surface of the molded article 300. For example, the ribs 320 and notches 322 may have a variable height H₃₂₀ or depth D₃₂₂, such that a first height H₃₂₀ or depth D₃₂₂ at a first portion of the ribs 320 or notches 322 may be different from a second height H₃₂₀ or depth D₃₂₂ at a second portion of the ribs 320 or notches 322. Additionally or alternatively, each of the ribs 320 and notches 322 may have a consistent height H₃₂₀ or depth D₃₂₂ and/or may vary depending on the desired weight and rigidity of the molded article 300. The outsole 302 and the molded article 300 may be configured with both variable height or depth ribs 320 and notches 322 as well as consistent height and depth ribs 320 and notches 322.

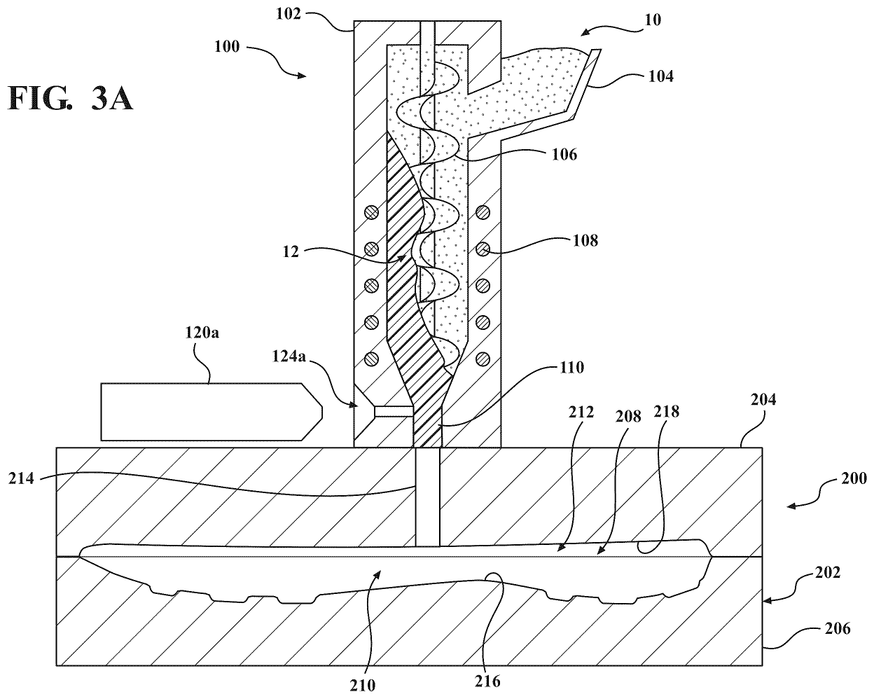

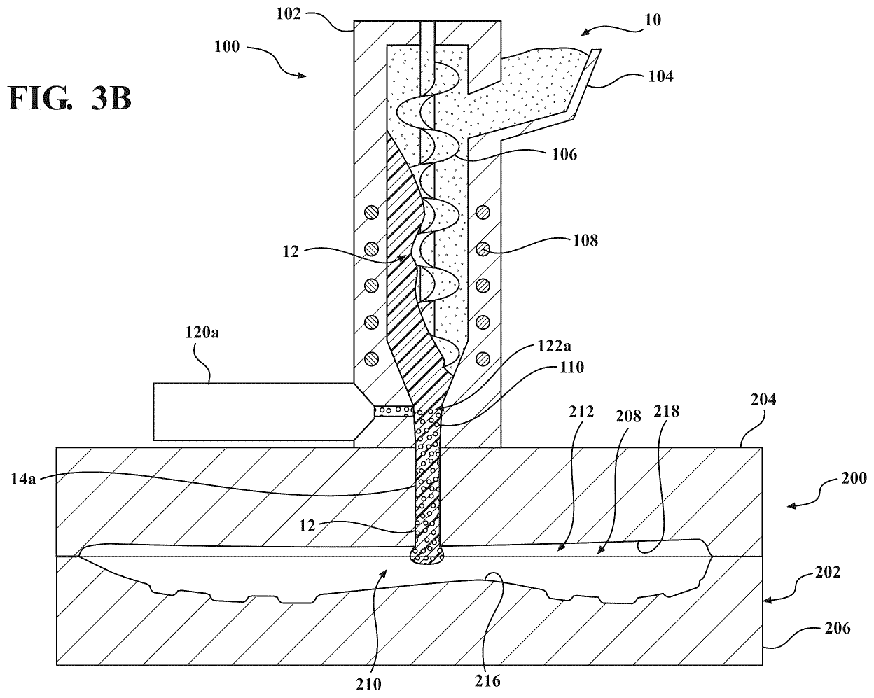

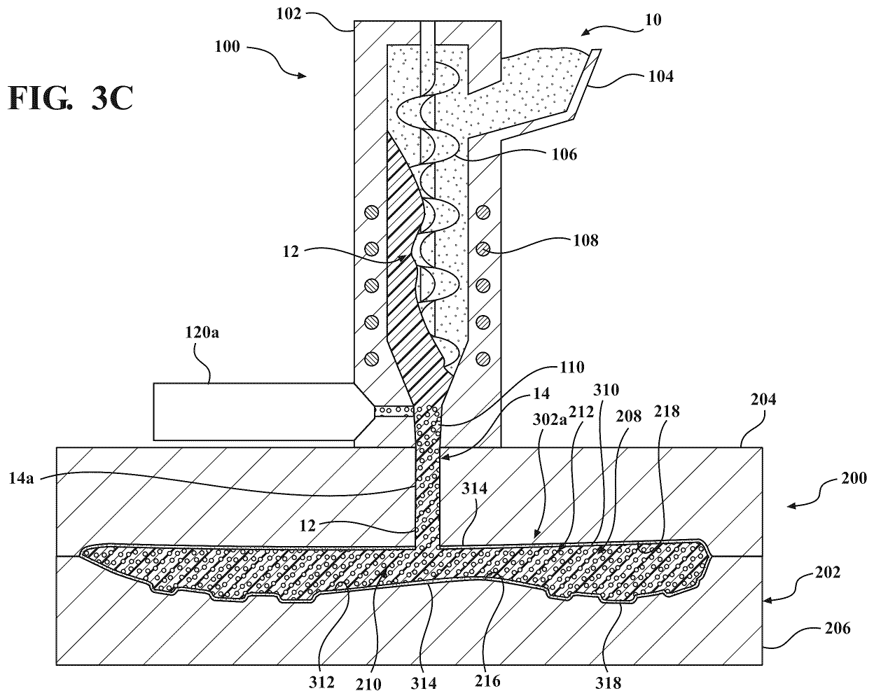

With particular reference to FIGS. 3A-3C, another example of use of the injection molding system 10 is provided. In view of the substantial similarity in structure and function of the components associated with the injection molding system 10 of FIGS. 2A-2C with respect to the injection molding system 10 of FIGS. 3A-3C, like reference numerals are used hereinafter and in the drawings to identify like components while like reference numerals containing letter extensions are used to identify those components that have been modified.

As discussed above, the injection molding system 10 may be configured to inject the mold material 12 into the mold system 200 in combination with a foaming agent 122a. In the example of FIGS. 3A-3C, the secondary injector 120a is a cartridge that stores the foaming agent 122a (i.e., an injection gas) and selectively expels the foaming agent 122a into the barrel 102. The foaming agent 122a is a gas that physically foams the mold material 12 upon contact. The gas of the foaming agent 122a may include, but is not limited to, a carbon dioxide or nitrogen gas. FIG. 3A illustrates a disengaged state of the secondary injector 120a, such that the secondary injector 120a is removed or separate from the injection system 100. The barrel 102 defines a receiving portion 124a designed to receive the cartridge 120a, with a channel 126a through which the foaming agent 122a may be directed.

As depicted in FIGS. 3B and 3C, the secondary injector 120a is coupled to the barrel 102 at the receiving portion 124a, and the foaming agent 122a is injected into the barrel 102. The foaming agent 122a is forced into the mold material 12 to define a cell structure 330a of the foamed mold material 14. The cell structure 330a is generally maintained during formation of the outsole 302a as the foamed center 316a. The cell structure 330a may be formed as a result of the injection of the foaming agent 122a (i.e., the forced compressed gas 122a mixing with the mold material 12). While the foamed center 316a maintains the cell structure 330a, the skin 314 is formed at the first and second plates 204, 206. Thus, the outsole 302a has a semi-rigid exterior as a result of the skin 314, which advantageously provides abrasion resistance during use, described in more detail below.

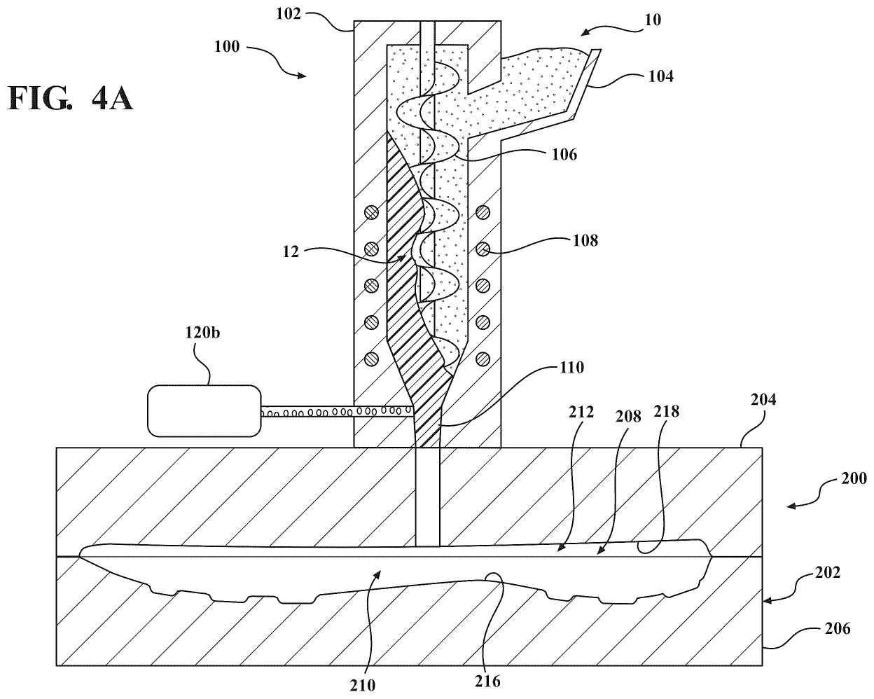

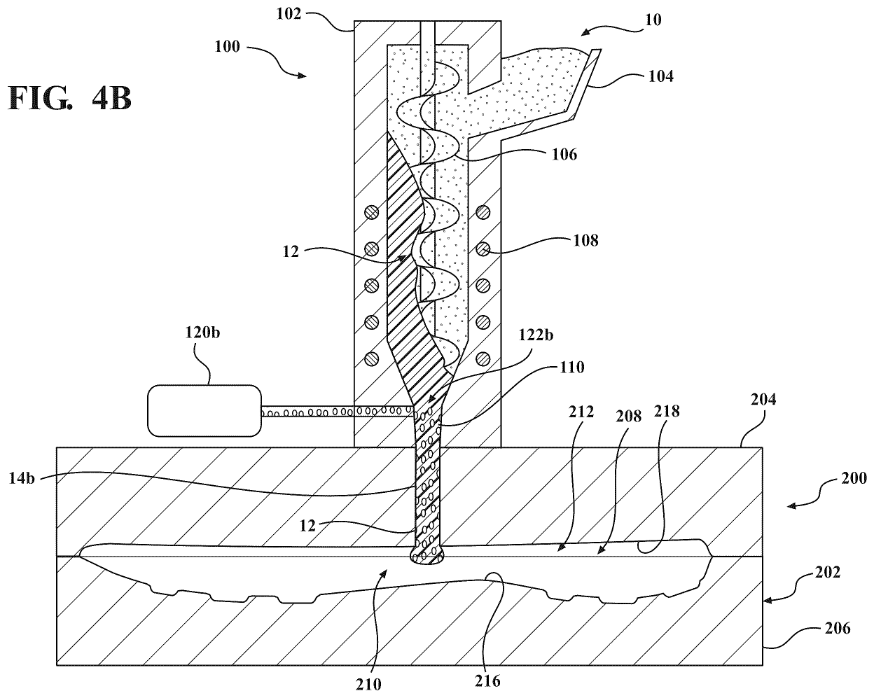

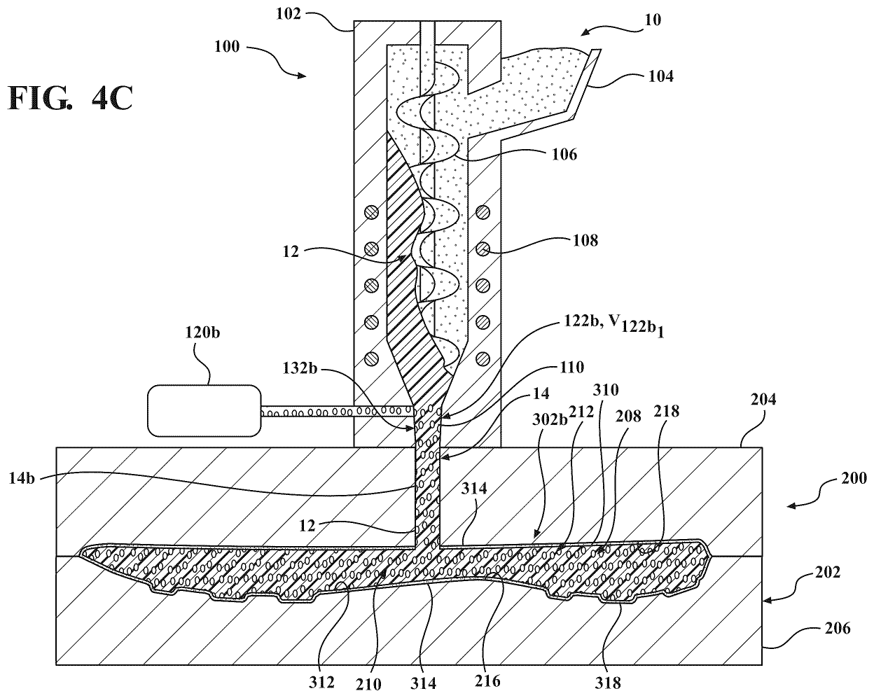

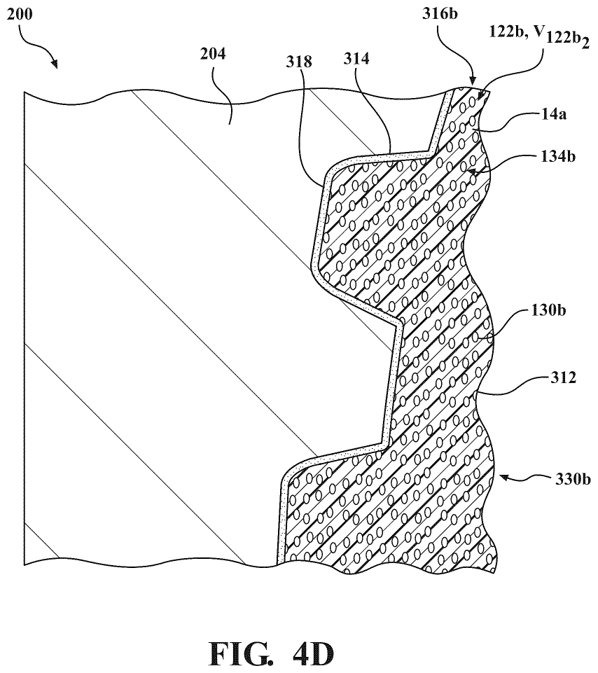

With particular reference to FIGS. 4A-4D, another example of use of the injection molding system 10 is provided. In view of the substantial similarity in structure and function of the components associated with the injection molding system 10 of FIGS. 2A-2C with respect to the injection molding system 10 of FIGS. 3A-3C, like reference numerals are used hereinafter and in the drawings to identify like components while like reference numerals containing letter extensions are used to identify those components that have been modified.

As discussed above, the injection molding system 10 may be configured to inject the mold material 12 into the mold system 200 in combination with a foaming agent 122b. In the example of FIGS. 4A-4D, the secondary injector 120b is configured to inject the foaming agent 122b into the barrel 102. The foaming agent 122b includes a plurality of microspheres 122b that expand in volume in response to pressure change as a result of passing from the heated nozzle 110 into the mold assembly 202. For example, the microspheres 122b are subject to a high pressure state when mixed with the mold material 12 at the nozzle 110. The high pressure state may be defined by the heat generated by the heater 108 proximate to the nozzle 110. As the mixture of the microspheres 122b and the mold material 12 passes through the nozzle 110, the foamed mold material 14b is defined.

The microspheres 122b define self-contained gas pockets (i.e., air pockets), such that the gas is contained by an expandable outer shell 130b. For example, the microspheres 122b are in a first state 132b having a first volume V_{122b1} prior to passing through the nozzle 110. Once the microspheres 122b are mixed with the mold material 12 and pass through the nozzle 110, the microspheres 122b transition into a second, expanded state 134b and have a second volume V_{122b2}. The second volume V_{122b2} is greater than the first volume V_{122b1} as a result of the expansion of the microspheres 122b. The expansion of the microspheres 122b occurs as a result of the gas being activated by the heat generated by the heater 108 and the release of pressure when moving from the high pressure state at the nozzle 110 to the low pressure state within the mold assembly 202. For example, as the microspheres 122b pass through the nozzle 110, there is a release of pressure, which results in the expansion of the microspheres 122b. The outer shell 130b is configured to expand in response to the change in pressure, while containing the gas.

The microspheres 122b thus define voids within the foamed center 316b of the outsole 302. As such, the microspheres 122b are retained within the foamed center 316b upon completion of the molding process to define a lighter, foamed center 316b, as compared to outsoles that are free of the foaming agent 122b. The microspheres 122b may be described as forming the cell structure 330b of the foamed center 316b. For example, FIG. 4D illustrates an enlarged portion of the outsole 302b, which has the expanded microspheres 122b within the mold material 12 to define the cell structure 330b of the foamed center 316b of the outsole 302b. Further, the skin 314 is illustrated relative to the foamed center 316b. The skin 314 may be formed as a result of the compression of the foamed mold material 14b within the mold assembly 202. For example, as the foamed mold material fills the mold assembly 202, the weight and pressure of the foamed mold material 14b may compress against the mold plates 204, 206 to define the skin 314.

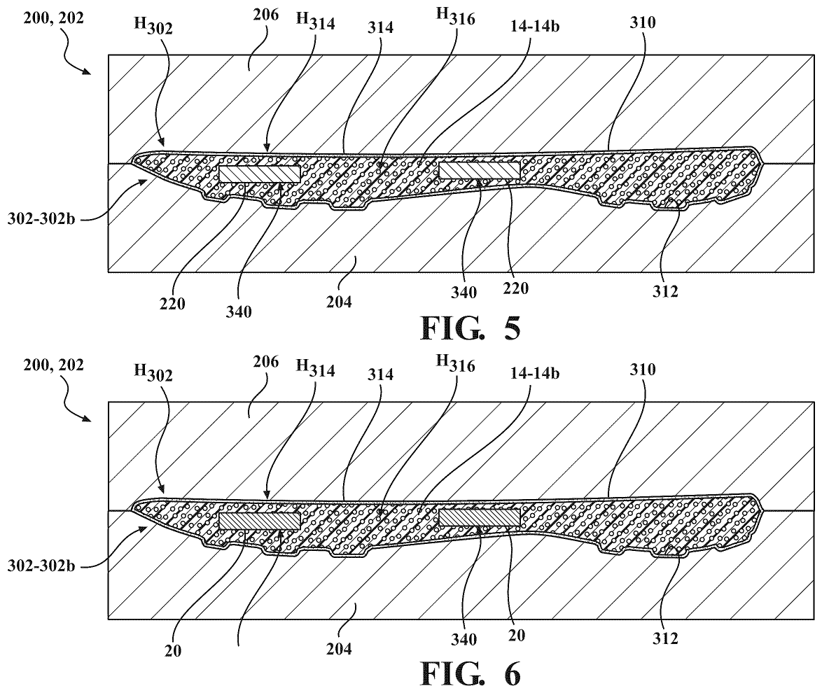

Referring again to FIGS. 2A-6, the mold assembly 202 may optionally include removable segments 220 that may be selectively positioned within the mold chamber 208. The removable segments 220 are configured to selectively block-off portions of the mold plate 204, 206 for the foamed mold material 14-14b to be injected around. The removable segments 220 may be positioned within the mold chamber 208 and removed upon completion of the injection process to define a cavity 340 within the foamed outsole 302-302b. In this example, a second mold material 20 may be injected into the cavity 340 to fill the cavity 340. The second mold material 20 may be foamed or may be free of the foaming agent 122-122b, such that the second mold material 20 may have a greater density as compared to the foamed mold material 14-14b.

In other examples, the first mold material 12 and the second mold material 20 may have different color compounds, such that the second mold material 20 may contrast with the foamed mold material 14-14b when injected into the mold assembly 202. It is contemplated that color additives (i.e., pigments) may be included with the mold materials 12, 20 to form a design or pattern of the foamed outsole 302-302b. Further, an abrasion resistant additive may be included with the mold materials 12, 20 to improve the overall abrasion resistance of the foamed outsole 302-302b, described in more detail below.

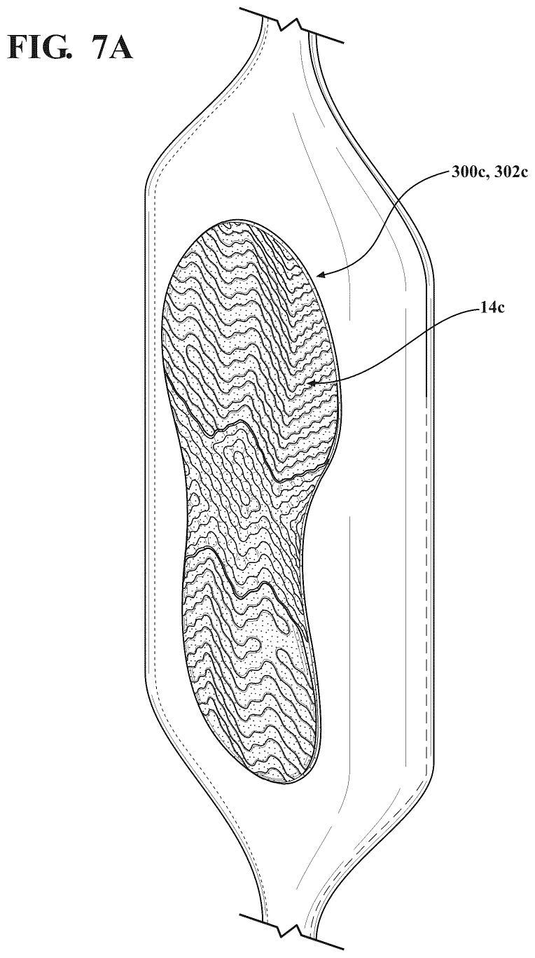

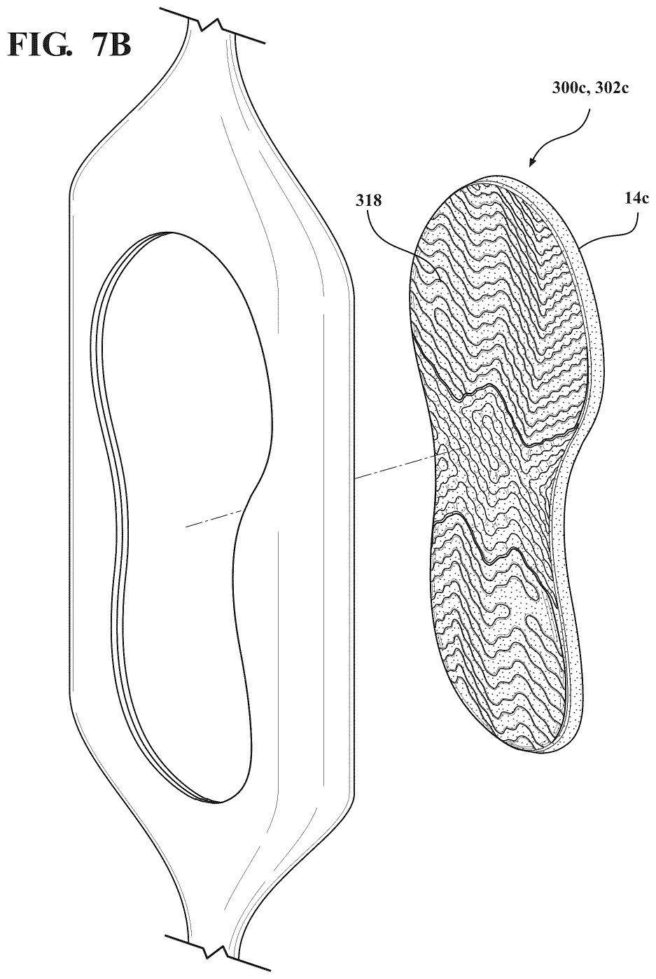

With particular reference to FIGS. 7A-7C, a molded article 300c according to another example of the disclosure is provided. In view of the substantial similarity in structure and function of the components associated with the molded article 300, like reference numerals are used hereinafter and in the drawings to identify like components while like reference numerals containing letter extensions are used to identify those components that have been modified.

The outsole 302c is formed via an extrusion process. The extrusion process includes combining a high grade mold material 12 and foaming the mold material 12 using one of the foaming agents 122, 122a described with respect to FIGS. 2A-3C. For example, the foaming agents 122, 122a may be injected into the mold material 12 prior to extrusion to define the foamed mold material 14c. In some instances, the extrusion process may include blow molding the foamed mold material 14c. After extruding the foamed mold material 14c, the extruded material 14c is die cut and pressed to form the foamed outsole 302c.

With reference to FIGS. 2A-9, the molded article 300-300c may be formed using any one of the injection and/or extrusion processes described above. In some instances, the injection processes described with respect to FIGS. 2A-4D may be combined to achieve the foamed outsole 302-302b. Further, as mentioned above, the injection processes described with respect to FIGS. 2A-4D may form the skin 314 of the outsole 302-302b in addition to the foamed center 316-316b. The skin 314 advantageously provides the foamed outsole 302-302b with improved abrasion resistance, as the skin 314 has a hardness H₃₁₄ that is greater than a hardness H₃₁₆ of the foamed center 316-316b.

While the hardness H₃₁₄ of the skin 314 is greater than the hardness H₃₁₆ of the foamed center 316-316b, the overall hardness H₃₀₂ of the foamed outsole 302 is reduced compared to non-foamed outsoles. For example, a non-foamed outsole may have a Shore hardness ranging from approximately 68 A to approximately 95 A. Comparatively, the hardness H₃₀₂ of the foamed outsole 302-302c may range from approximately 40 A to approximately 80 A. Thus, the foamed outsole 302 advantageously provides a wearer with increased cushioning properties and comfort as a result of the reduced hardness H₃₀₂. While the overall hardness H₃₀₂ of the foamed outsole 302 is reduced, the hardness H₃₁₄ of the skin 314 assists in minimizing the potential abrasion that may result from a reduced level of hardness H₃₀₂.

For example, the skin 314 forms a shell around the foamed center 316 to protect the foamed center 316 from direct ground-engaging contact. As the hardness H₃₁₄ of the skin is greater than the hardness H₃₁₆ of the foamed center 316, the skin 314 is configured to withstand greater levels of contact and abrasion. In some instances, the outsole 302c is free of the skin 314 due to the manufacturing process. In these examples, the mold material 12 may be combined with abrasion resistant additives, such as carbon black and/or graphene, to improve the durability of the outsole 302c. It is contemplated that the abrasion resistant additives may also be added to the mold material 12 of the outsole 302-302b that includes the skin 314. In some instances, the outsole 302c may have a skin 314, such that a secondary press step may be performed to form the skin 314 along the bottom portion 312 of the outsole 302c. For example, a bottom surface 332 of the outsole 302c may be melted to a degree to perform the secondary press step in order to form the skin 314.

In other examples, the foamed mold material 12 may be combined with a non-foamed mold material 20 to increase the durability of the outsole 302-302c. For example, selective portions of the outsole 302-302b may be blocked-off by the removable segments 220 and subsequently filled with a non-foamed, second mold material 20. In the example of extruding the outsole 302c, the cavities 340 may be extruded to provide areas for the second, non-foamed material 20 to be added to the extruded outsole 302c. The combination of the second, non-foamed material 20 with the foamed mold material 14 provides the outsole 302-302c with a level of high durability in portions while also providing an overall soft, cushioned structure. In some examples, pigment or other color additives may be added to the mold material 12 to customize a design of the outsole 302-302c. The mold material 12 may be prepared with the pigment using a twin extruder to mix the pigment with the mold material 12. The mixture is prepared prior to forming the pellets of the mold material 12, such that the pellets of the mold material 12 would include both the mold material 12 and the pigment.

With further reference to FIGS. 1-9, in some examples, the foamed mold material 14 may be injected over an object or material disposed within the mold assembly 202. For example, the foamed mold material 14 may be overmolded with another object or material. In some instances, the material may be the same material as one of the mold material 12 or the foamed mold material 14. In other examples, the material may be different from the mold material 12 and/or the foamed mold material 14. The outsole 302-302c is foamed to form an open cell structure 330, which advantageously provides added cushioning and comfort to the article of footwear 304. While the foamed outsole 302-302c provides improved cushioning at the outsole 302-302c of the footwear 304, the ribs 320 can provide selective structural support.

For example, the ribs 320 may provide added stiffness in select areas to balance the open cell structure 330 of the foamed outsole 302-302c. Further, the notches 322 may be utilized to define open areas of the outsole 302-302c with minimal waste, while reducing the overall weight of the foamed outsole 302-302c. The quantity of ribs 320 and/or notches 322 may depend on the desired structure and stiffness of the outsole 302-302c. The ribs 320 may be added along the top portion 310 and/or the bottom portion 312 to define an increased degree of stiffness for the foamed outsole 302-302c. When the ribs 320 are formed along the bottom portion 312, the ribs 320 may also provide additional traction functionality, such that the traction elements 318 may correspond with the ribs 320.

The following Clauses provide an exemplary method of forming a sole structure and an outsole for an article of footwear described above. The Clauses also provide an exemplary method of forming an article of footwear described above.
Clause 1. A method of forming an outsole for an article of footwear, the method including providing, at an injection system, a mold material, the mold material including a styrenic thermoplastic elastomer, providing, at a barrel of the injection system, a foaming agent, combining the foaming agent with the mold material and forming a mixture of the foaming agent and the mold material, injecting the mixture into a mold assembly, and forming, at the mold assembly, an outsole from the injected foamed mold material.
Clause 2. The method of Clause 1, wherein combining the foaming agent with the mold material includes injecting the foaming agent into the mold material at a nozzle of the injection system.
Clause 3. The method of either of Clauses 1 or 2, wherein the foaming agent includes at least one of a chemical blowing agent, an injection gas, and microspheres.
Clause 4. The method of any of Clauses 1-3, wherein forming the outsole includes forming a skin along mold plates of the mold assembly.
Clause 5. The method of Clause 3, wherein injecting the foamed mold material includes heating the microspheres of the foaming agent and expanding a volume of each of the microspheres within the foamed mold material.
Clause 6. The method of any of the preceding Clauses, further including defining notches in the outsole.
Clause 7. The method of any of the preceding Clauses, further including forming ribs of the outsole.
Clause 8. The method of any of the preceding Clauses, further including positioning one or more removable segments in the mold assembly to define one or more cavities of the outsole and injecting a second mold material into the cavities.
Clause 9. An outsole for an article of footwear formed using the method of any of the preceding Clauses.
Clause 10. An article of footwear including the outsole of Clause 9.
Clause 11. A method of forming an outsole for an article of footwear, the method including providing a mold material, the mold material including a styrenic thermoplastic elastomer, providing a foaming agent, combining the foaming agent with the mold material and forming a mixture of the foaming agent and the mold material, and forming a foamed outsole from the mixture.
Clause 12. The method of Clause 11, wherein providing the mold material includes providing the mold material at an injection system, and wherein combining the foaming agent with the mold material includes injecting the foaming agent into the mold material at a nozzle of the injection system.
Clause 13. The method of either of Clauses 1 or 2, wherein the foaming agent includes at least one of a chemical blowing agent, an injection gas, and microspheres.
Clause 14. The method of any of the preceding Clauses, wherein forming the outsole includes forming a skin along mold plates of the mold assembly.
Clause 15. The method of Clause 3, wherein injecting the foamed mold material includes heating the microspheres of the foaming agent and expanding a volume of each of the microspheres within the foamed mold material.
Clause 16. The method of any of the preceding Clauses, further including defining notches in the outsole.
Clause 17. The method of any of the preceding Clauses, further including forming ribs of the outsole.
Clause 18. The method of any of the preceding Clauses, further including positioning one or more removable segments in the mold assembly to define one or more cavities of the outsole and injecting a second mold material into the cavities.
Clause 19. An outsole for an article of footwear formed using the method of any of the preceding Clauses.
Clause 20. An article of footwear including the outsole of Clause 19.
Clause 21. A foamed outsole for an article of footwear including an outer layer having a first hardness and an inner layer including a foamed center and having a second hardness, the first hardness being greater than the second hardness.
Clause 22. The foamed outsole of Clause 21, wherein the inner layer includes a mixture including a mold material and a foaming agent, the mold material.
Clause 23. The foamed outsole of Clause 22, wherein the mold material is an elastomeric material including one or more thermoplastic polymers.
Clause 24. The foamed outsole of either of Clauses 22 or 23, wherein the mold material is a styrenic thermoplastic elastomeric material.
Clause 25. The foamed outsole of any of Clauses 22-24, wherein the outer layer has a first density and the inner layer has a second density, the second density being less than the first density.
Clause 26. The foamed outsole of any of the preceding Clauses, further including at least one rib extending from the outer layer.
Clause 27. The foamed outsole of Clause 26, wherein the at least one rib extends along a longitudinal axis of the foamed outsole.
Clause 28. The foamed outsole of either of Clauses 26 or 27, wherein the at least one rib extends between a medial side of the foamed outsole and a lateral side of the foamed outsole.
Clause 29. The foamed outsole of any of Clauses 26-28, wherein the at least one rib has a variable height, the at least one rib having a first height at a first portion of the at least one rib and a second height at a second portion of the at least one rib, the first height being different from the second height.
Clause 30. The foamed outsole of any of Clauses 26-28, wherein the at least one rib has a consistent height from a first end of the at least one rib to a second end of the at least one rib.
Clause 31. The foamed outsole of any of the preceding Clauses, further including at least one notch defined in the outer layer.
Clause 32. The foamed outsole of Clause 31, wherein the at least one notch extends along a longitudinal axis of the foamed outsole.
Clause 33. The foamed outsole of either of Clauses 31 or 32, wherein the at least one notch extends between a medial side of the outsole and a lateral side of the outsole.
Clause 34. The foamed outsole of any of Clauses 31-33, wherein the at least one notch has a variable depth, the at least one notch having a first depth at a first portion of the at least one notch and a second depth at a second portion of the at least one notch, the first depth being different from the second depth.
Clause 35. The foamed outsole of any of Clauses 31-33, wherein the at least one notch has a consistent height from a first end of the at least one notch to a second end of the at least one notch.
Clause 36. The foamed outsole of any of the preceding Clauses, wherein the foamed center of the inner layer includes a foaming agent, the foaming agent including at least one of a chemical blowing agent, an injection gas, and microspheres.
Clause 37. A foamed outsole for an article of footwear including an outer layer having a first hardness and an inner layer having a second hardness, the first hardness being greater than the second hardness and the inner layer including a chemical blowing agent.
Clause 38. The foamed outsole of Clause 37, wherein the inner layer includes a mixture including a mold material and a foaming agent, the mold material.
Clause 39. The foamed outsole of Clause 38, wherein the mold material is an elastomeric material including one or more thermoplastic polymers.
Clause 40. The foamed outsole of either of Clauses 38 or 39, wherein the mold material is a styrenic thermoplastic elastomeric material.
Clause 41. The foamed outsole of any of Clauses 38-40, wherein the outer layer has a first density and the inner layer has a second density, the second density being less than the first density.
Clause 42. The foamed outsole of any of the preceding Clauses, further including at least one rib extending from the outer layer.
Clause 43. The foamed outsole of Clause 42, wherein the at least one rib extends along a longitudinal axis of the foamed outsole.
Clause 44. The foamed outsole of either of Clauses 42 or 43, wherein the at least one rib extends between a medial side of the foamed outsole and a lateral side of the foamed outsole.
Clause 45. The foamed outsole of any of Clauses 42-44, the at least one rib has a variable height, the at least one rib having a first height at a first portion of the at least one rib and a second height at a second portion of the at least one rib, the first height being different from the second height.
Clause 46. The foamed outsole of any of Clauses 42-44, wherein the at least one rib has a consistent height from a first end of the at least one rib to a second end of the at least one rib.
Clause 47. The foamed outsole of any of the preceding Clauses, further including at least one notch defined in the outer layer.
Clause 48. The foamed outsole of Clause 47, wherein the at least one notch extends along a longitudinal axis of the foamed outsole.
Clause 49. The foamed outsole of either of Clauses 47 or 48, wherein the at least one notch extends between a medial side of the outsole and a lateral side of the outsole.
Clause 50. The foamed outsole of any of Clauses 47-49, wherein the at least one notch has a variable depth, the at least one notch having a first depth at a first portion of the at least one notch and a second depth at a second portion of the at least one notch, the first depth being different from the second depth.
Clause 51. The foamed outsole of any of Clauses 47-49, wherein the at least one notch has a consistent height from a first end of the at least one notch to a second end of the at least one notch.
Clause 52. A foamed outsole for an article of footwear including an outer layer having a first hardness and an inner layer including a foamed center including an injection gas, the inner layer having a second hardness, the first hardness of the outer layer being greater than the second hardness of the inner layer.
Clause 53. The foamed outsole of Clause 52, wherein the inner layer includes a mixture including a mold material and a foaming agent, the mold material.
Clause 54. The foamed outsole of Clause 53, wherein the mold material is an elastomeric material including one or more thermoplastic polymers.
Clause 55. The foamed outsole of either of Clauses 53 or 54, wherein the mold material is a styrenic thermoplastic elastomeric material.
Clause 56. The foamed outsole of any of Clauses 53-55, wherein the outer layer has a first density and the inner layer has a second density, the second density being less than the first density.
Clause 57. The foamed outsole of any of the preceding Clauses, further including at least one rib extending from the outer layer.
Clause 58. The foamed outsole of Clause 57, wherein the at least one rib extends along a longitudinal axis of the foamed outsole.
Clause 59. The foamed outsole of either of Clauses 57 or 58, wherein the at least one rib extends between a medial side of the foamed outsole and a lateral side of the foamed outsole.
Clause 60. The foamed outsole of any of Clauses 57-59, wherein the at least one rib has a variable height, the at least one rib having a first height at a first portion of the at least one rib and a second height at a second portion of the at least one rib, the first height being different from the second height.
Clause 61. The foamed outsole of any of Clauses 57-59, wherein the at least one rib has a consistent height from a first end of the at least one rib to a second end of the at least one rib.
Clause 62. The foamed outsole of any of the preceding Clauses, further including at least one notch defined in the outer layer.
Clause 63. The foamed outsole of Clause 62, wherein the at least one notch extends along a longitudinal axis of the foamed outsole.
Clause 64. The foamed outsole of either of Clauses 62 or 63, wherein the at least one notch extends between a medial side of the outsole and a lateral side of the outsole.
Clause 65. The foamed outsole of any of Clauses 62-64, wherein the at least one notch has a variable depth, the at least one notch having a first depth at a first portion of the at least one notch and a second depth at a second portion of the at least one notch, the first depth being different from the second depth.
Clause 66. The foamed outsole of any of Clauses 62-64, wherein the at least one notch has a consistent height from a first end of the at least one notch to a second end of the at least one notch.
Clause 67. A foamed outsole for an article of footwear including an outer layer having a first hardness and an inner layer including a foamed center including microspheres, the inner layer having a second hardness, the first hardness of the outer layer being greater than the second hardness of the inner layer.
Clause 68. The foamed outsole of Clause 67, wherein the inner layer includes a mixture including a mold material and a foaming agent, the mold material.
Clause 69. The foamed outsole of Clause 68, wherein the mold material is an elastomeric material including one or more thermoplastic polymers.
Clause 70. The foamed outsole of either of Clauses 68 or 69, wherein the mold material is a styrenic thermoplastic elastomeric material.
Clause 71. The foamed outsole of any of Clauses 68-70, wherein the outer layer has a first density and the inner layer has a second density, the second density being less than the first density.
Clause 72. The foamed outsole of any of the preceding Clauses, further including at least one rib extending from the outer layer.
Clause 73. The foamed outsole of Clause 72, wherein the at least one rib extends along a longitudinal axis of the foamed outsole.
Clause 74. The foamed outsole of either of Clauses 72 or 73, wherein the at least one rib extends between a medial side of the foamed outsole and a lateral side of the foamed outsole.
Clause 75. The foamed outsole of any of Clauses 72-74, wherein the at least one rib has a variable height, the at least one rib having a first height at a first portion of the at least one rib and a second height at a second portion of the at least one rib, the first height being different from the second height.
Clause 76. The foamed outsole of any of Clauses 72-74, wherein the at least one rib has a consistent height from a first end of the at least one rib to a second end of the at least one rib.
Clause 77. The foamed outsole of any of the preceding Clauses, further including at least one notch defined in the outer layer.
Clause 78. The foamed outsole of Clause 77, wherein the at least one notch extends along a longitudinal axis of the foamed outsole.
Clause 79. The foamed outsole of either of Clauses 77 or 78, wherein the at least one notch extends between a medial side of the outsole and a lateral side of the outsole.
Clause 80. The foamed outsole of any of Clauses 77-79, wherein the at least one notch has a variable depth, the at least one notch having a first depth at a first portion of the at least one notch and a second depth at a second portion of the at least one notch, the first depth being different from the second depth.
Clause 81. The foamed outsole of any of Clauses 77-79, wherein the at least one notch has a consistent height from a first end of the at least one notch to a second end of the at least one notch.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method of forming an outsole for an article of footwear, the method comprising:
providing, at an injection system, a mold material, the mold material including a styrenic thermoplastic elastomer;
providing, at a barrel of the injection system, a foaming agent;
combining the foaming agent with the mold material and forming a mixture of the foaming agent and the mold material;
injecting the mixture into a mold assembly; and
forming, at the mold assembly, an outsole from the mixture.

2. The method of claim 1, wherein combining the foaming agent with the mold material includes injecting the foaming agent into the mold material at a nozzle of the injection system.

3. The method of claim 1, wherein the foaming agent includes at least one of a chemical blowing agent, an injection gas, and microspheres.

4. The method of claim 1, wherein forming the outsole includes forming a skin along mold plates of the mold assembly.

5. The method of claim 3, wherein injecting the mixture includes heating the microspheres of the foaming agent and expanding a volume of each of the microspheres within the mixture.

6. The method of claim 1, further including defining notches in the outsole.

7. The method of claim 1, further including forming ribs of the outsole.

8. The method of claim 1, further including positioning one or more removable segments in the mold assembly to define one or more cavities of the outsole and injecting a second mold material into the cavities.

9. An outsole for an article of footwear formed using the method of claim 1.

10. An article of footwear including the outsole of claim 9.

11. A method of forming an outsole for an article of footwear, the method comprising:
providing a mold material, the mold material including a styrenic thermoplastic elastomer;
providing a foaming agent;
combining the foaming agent with the mold material and forming a mixture of the foaming agent and the mold material; and
forming a foamed outsole from the mixture.

12. The method of claim 11, wherein providing the mold material includes providing the mold material at an injection system, and wherein combining the foaming agent with the mold material includes injecting the foaming agent into the mold material at a nozzle of the injection system.

13. The method of claim 11, wherein the foaming agent includes at least one of a chemical blowing agent, an injection gas, and microspheres.

14. The method of claim 11, wherein forming the foamed outsole includes forming a skin along mold plates of a mold assembly.

15. The method of claim 13, further including injecting, into a mold assembly, the mixture including the microspheres and expanding a volume of each of the microspheres within the mixture.

16. The method of claim 11, further including defining notches in the foamed outsole.

17. The method of claim 11, further including forming ribs of the foamed outsole.

18. The method of claim 11, further including positioning one or more removable segments in a mold assembly to define one or more cavities of the foamed outsole and injecting a second mold material into the one or more cavities.

19. The method of claim 11, further including combining, with the mold material, at least one of a pigment and an abrasion resistance additive.

20. A foamed outsole for an article of footwear formed using the method of claim 11.
